(19) United States
(12) Patent Application Publication
(10) Pub. No.: US 2007/0219804 A1
(43) Pub. Date: Sep. 20, 2007

(54) Processing apparatus of markup language information, information processing method and recording medium with program

(75) Inventor: Akihiko Asayama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/477,176

(22) Filed: Jun. 28, 2006

(30) Foreign Application Priority Data
Mar. 16, 2006 (JP) JP2006-072864

(51) Int. Cl. G10L 21/00

(52) U.S. Cl. 704/275

(57) ABSTRACT

An apparatus includes a recording tag recognition unit 1 recognizing a recording tag representing a start of recording, a recording termination tag recognition unit 1 recognizing a recording termination tag representing termination of recording, and a voice data storage control unit 2 having acquired voice data stored during a period till the recording termination tag is recognized after the recording tag has been recognized, and having a outputted voice stored as voice data.

### BACKGROUND OF THE INVENTION

The present invention relates to a voice processing technology based on Markup Language information.

At the present, there is a function of recording a content of user's utterances by employing a tag <record> in VoiceXML 2.0 (http://www.w3.org/TR/voicexml20/) by W3C standards that are generally utilized in a voice dialog system.

FIG. 1 shows an example of data of conventional VoiceXML. In the conventional VoiceXML, a tag <form> represents a start of a dialog process, and a tag </form> represents an end of the dialog process. Accordingly, the dialog process is executed in a range (which is called a scope) from <form> to </form>.

Moreover, a scope ranging from <prompt> to </prompt> represents a process of synthesizing a voice and making an utterance on a system side. This tag <prompt> triggers execution of synthesizing the voice and uttering the synthesized voice. Further, such an application program is executed that an input content of an answer utterance from a user in response to a synthetically uttered content (synthetic utterance) is acquired and set as a result of recognition by combining and thus employing a tag set called an input item.

On the other hand, a scope from <record> to </record> is a description of designating execution of a recording function. In this example, the designation is that a recording content is recorded in a file designated by name=“msg”, a beep sound is uttered, the recording continues for 10 sec at the maximum, and the recording is terminated after a 4-sec silence status.

In the example of the description in FIG. 1, a dialog sequence becomes as shown in FIG. 2. Herein, the symbol “C:” represents a system utterance, while “H:” presents a user's utterance. In the conventional process based on <record>, it follows that only the voices uttered by the user in the scope ranging from <record> to </record> in a series of dialogs are to be recorded.

[Patent document 1] Japanese Patent Application Laid-Open Publication No. 2003-15860

[Patent document 2] Patent Application Laid-Open Publication No. 2002-324158

[Patent document 3] Patent Application Laid-Open Publication No. 2002-108794

### SUMMARY OF THE INVENTION

As in the example given above, in the description using <record>, only the content (“Television” in the example in FIG. 2) uttered by the user for recording is recorded in a recording file, however, this is not the recording that contains the system utterances before and after this user's utterance, and therefore the following problems arise.

(1) It is hard to recognize which dialog the recorded content corresponds to.

(2) The user is required to utter while being aware of being recorded because this recording is not the dialog recording. For instance, the user needs to check what point of time the recording is started at (the user needs to carefully wait for utterance of the beep sound). Further, it is required that the user utters while being concerned about the maximum recording time.

(3) It is required for recording a plurality of user's utterances to write <record> at each of the user utterance points and to manage the recording files generated by the number of tags <record>.

The present invention aims at providing a function of recording and managing both of system utterances and user's utterances at arbitrary dialog points in a dialog sequence order.

The present invention adopts the following technology in order to solve the problems. Namely, the present invention is a processing apparatus of Markup Language information containing tag information for instructing execution of a predetermined function, comprising, an interface making connectable a voice acquisition unit, an interface making connectable a voice output unit, a voice acquisition control unit acquiring a voice as voice data via the voice acquisition unit, a voice output control unit outputting the voice via the voice output unit, a voice data storage unit stored with the voice data, a recording tag recognition unit recognizing a recording tag representing a start of recording, a recording termination tag recognition unit recognizing a recording termination tag representing termination of recording, and a voice data storage control unit having the voice data storage unit stored with the voice data acquired by the voice acquisition control unit during a period till the recording termination tag is recognized after the recording tag has been recognized, and having the voice data storage unit stored with a voice as voice data outputted by the voice output control unit.

According to the present invention, the voice data acquired by the voice acquisition control unit is stored in the voice data storage unit during the period till the recording termination tag is recognized after the recording tag has been recognized, and the voice data storage unit is stored with the voice outputted as the voice data by the voice output control unit. Accordingly, it is possible to store the acquired voice data and the outputted voice data as the dialog according to the designation of the tag.

The voice data storage control unit may connect the acquired voice data with the voice data of the outputted voice in a timer-series order at a point of time when being acquired and at a point of time when being outputted, and may store these pieces of voice data as one set of voice data. According to the present invention, the dialog is stored as the voice data connected into one data set.

The voice data storage control unit may include a data file storing unit storing the acquired voice data and the voice data of the outputted voice in a data file corresponding to the point of time when being acquired and in a data file corresponding to the point of time when being outputted, and an order recording unit recording, in an order storage file, a relationship of the time-series order with respect to the data file corresponding to the point of time when being acquired and the data file corresponding to the point of time when being outputted. According to the present invention, the voice data stored in the data file corresponding to the point of time when acquired and the voice data stored in the data file corresponding to the point of time when outputted, are stored corresponding to each other as the dialog in the order storage file.

The processing apparatus may further comprise an attribute recognition unit recognizing attribute information when storing the voice data, and the voice data storage control unit may have any one or both of the acquired voice data and the voice data of the outputted voice stored according to the attribute information. According to the present invention, any one or both of the acquired voice data and the voice data of the outputted voice is or are selectively stored.

Further, the present invention may be a method by which a computer, other devices, machines, etc execute any one of the processes described above. Still further, the present invention may also be a program executable by the computer, which makes the computer, other devices, machines, etc execute any one of the processes described above. Yet further, the present invention may also be a recording medium recorded with such a program that is readable by the computer, other devices, machines, etc.

### EFFECTS OF THE INVENTION

According to the present invention, it is possible to record and manage both of system utterances and user's utterances at arbitrary dialog points in a dialog sequence order.

### BRIEF DESCRIPTION OF THE DRAWINGS

FIG. 1 is an example of conventional VoiceXML data;

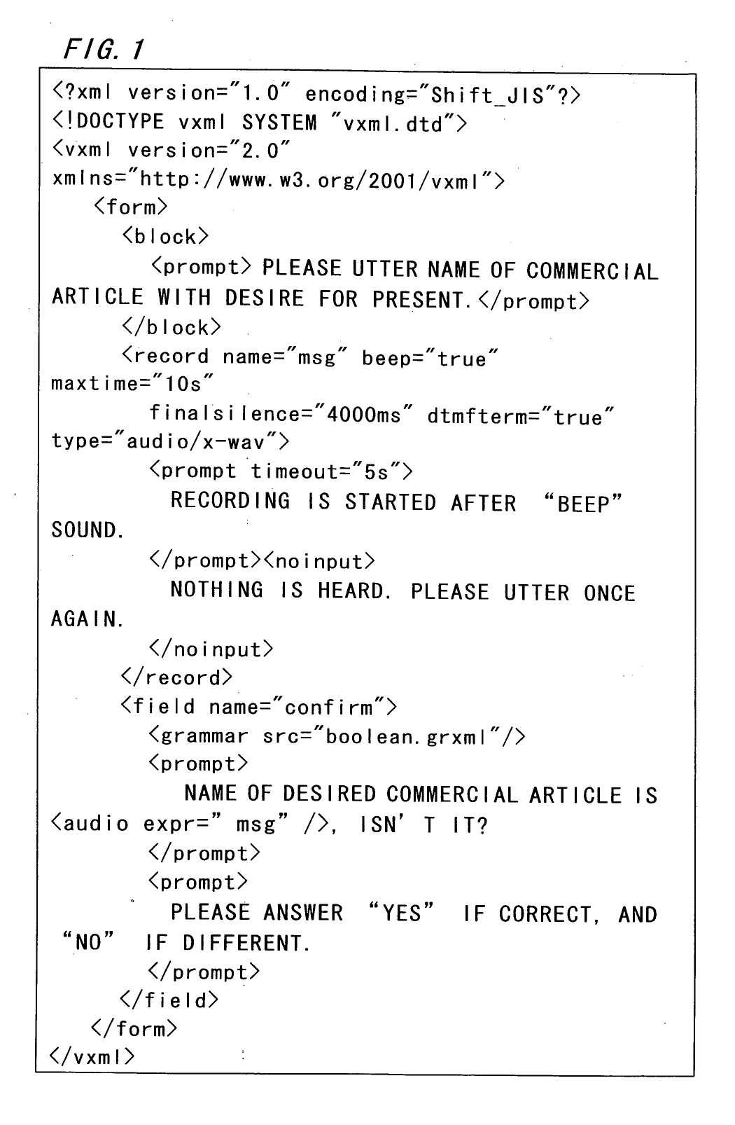

FIG. 2 is an example of a dialog based on the conventional VoiceXML data;

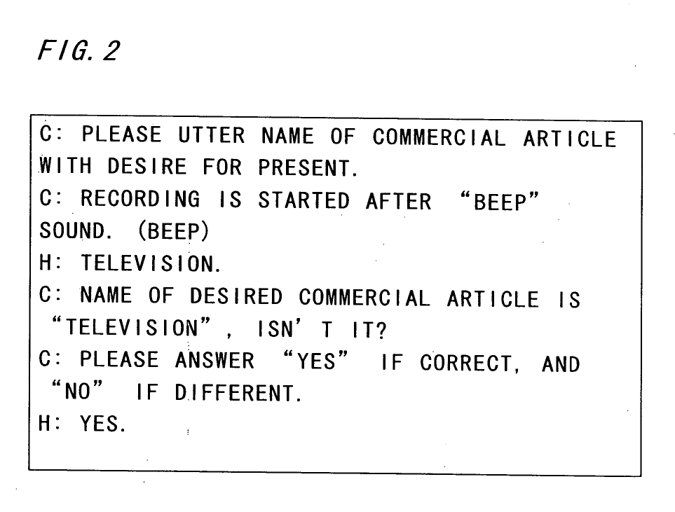

FIG. 3 is a diagram of a system configuration of an information processing apparatus according to one embodiment of the present invention;

FIG. 4 is an example of VoiceXML data containing dialog recording tags;

FIG. 5 is an example of data of a dialog recording file;

FIG. 6 is an example of data of a synthetic utterance recording file and data of a user's utterance recording file;

FIG. 7 is an example of data of a dialog recording management file;

FIG. 8 is an example of a process of outputting the dialog to the dialog recording file;

FIG. 9 is an example of a process of outputting the data to the synthetic utterance recording file, the user's utterance recording file and the dialog recording management file;

FIG. 10 is an example of a process of an attribute.

### DETAILED DESCRIPTION OF THE INVENTION

An information processing system according to a best mode (which will hereinafter be termed an embodiment) for carrying out the present invention will hereinafter be described with reference to the drawings. A configuration in the following embodiment is an exemplification, and the present invention is not limited to the configuration in the embodiment.

### Substance of the Invention

A dialog recording tag (e.g., <voicelog>) is prepared as a tag for recording an arbitrary dialog and is utilized in a voice dialog application described in the Markup Language such as VoiceXML. At an execution time, a dialog recording function in the arbitrary dialog is actualized by carrying out a dialog record within a scope (which is a range extending from <voicelog> to </voicelog>) in which the dialog recording tag is described.

Provided is a function capable of recording (dialog record) a content of a dialog (system's utterance +user's utterance) as it is in the scope where the dialog recording tags are described, thereby actualizing a function that could not be realized by the conventional technologies, i.e., recording of the content of the user's utterance on a dialog basis under the control of the application, or dialog recording. This enables acquisition of usage state information about proof safekeeping based on the dialog record, misrecognition/misoperation, etc. This type of dialog record enables the acquisition of a variety of information useful for the system operation such as improving the application or improving the dialog system.

### First Embodiment

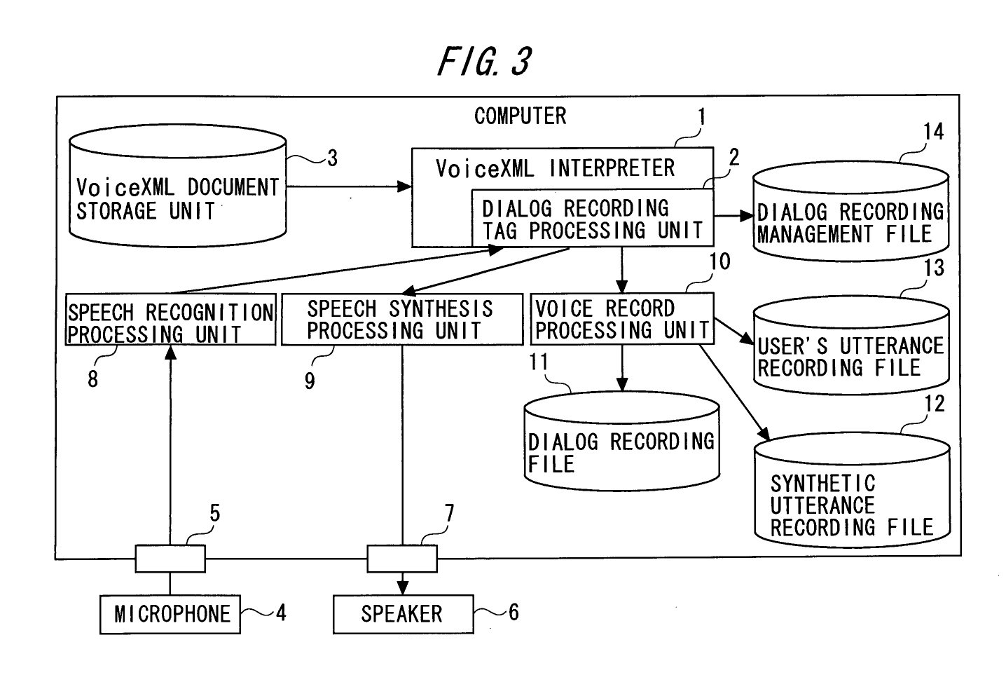

An information processing system according to a first embodiment of the present invention will hereinafter be described with reference to the drawings in FIGS. 3 through 9.

### System Configuration

FIG. 3 shows a diagram of a configuration of a whole system including a dialog recording tag processing mechanism. The first embodiment exemplifies an example of the configuration in the case of using VoiceXML (Voice Extensible Markup Language) as a voice dialog application.

The information processing system includes, as pieces of hardware, a CPU, a memory, an input/output interface, an external storage device such as a hard disk, a detachable recording medium such as a CD and a DVD, a voice input interface, a voice output interface and so on. A configuration of this type of computer is widely known, and therefore its explanation is omitted. Functions of the information processing system are actualized by the CPU's executing a computer program.

As shown in FIG. 3, the information processing system includes a VoiceXML interpreter 1 (corresponding to a recording tag recognition unit and a recording termination tag recognition unit according to the present invention) that interprets and executes the VoiceXML, a dialog recording tag processing unit 2 (corresponding to a voice data storage control unit according to the present invention) that is built in the VoiceXML interpreter 1 and executes the dialog recording, a VoiceXML document storage unit 3 stored with data of VoiceXML processed by the VoiceXML interpreter 1, a voice input interface 5 (corresponding to an interface making connectable a voice acquisition unit according to the present invention) making a microphone 4 connectable, a voice output interface 7 (corresponding to an interface making connectable a voice output unit according to the present invention) making a speaker 6 connectable, a speech recognition processing unit 8 (corresponding to a voice acquisition control unit according to the present invention) that processes a voice captured from the microphone 4 via the voice input interface 5, a speech synthesis processing unit 9 (corresponding to a voice output control unit according to the present invention) that synthesizes a voice and transmits the voice to the speaker via the voice output interface 7, a voice record processing unit 10 that records the voice captured from the speech recognition processing unit 8 and the speech synthesized by the speech synthesis processing unit 9, a dialog recording file 11 that combines (organizes) dialog contents as they are and are stored with the combined (organized) dialog contents as voice data, a synthetic utterance recording file 12 that records utterances in the dialog contents, as voice data, which are synthesized by the speech synthesis processing unit 9, a user's utterance recording file 13 that records user's utterances, as the voice data, in the dialog contents, and a dialog recording management file 14 (corresponding to an order storage file according to the present invention) that organizes the dialog recording contents by combining the synthetic utterances of the synthetic utterance recording file 12 with the user's utterances of the user's utterance recording file 13.

The VoiceXML interpreter 1 analyzes the well-known VoiceXML data and executes a function designated in a tag format in the VoiceXML data. The VoiceXML is utilized in combination with a speech recognition engine, a speech synthesis engine, etc and is capable of describing a structure of an interactive application by the XML, such as reading a choice, accepting an input in voice and reading a content corresponding to the input. The VoiceXML can describe user interfaces by a unified method, which were not unified so far among products.

Further, there is an example of providing an information service (which is called “voice portal” etc) in which a mobile phone network operator can perform input/output operations in voice, wherein a content holder can provide a voice support Web site without requiring a special technology owing to the voiceXML.

The VoiceXML document storage unit 3 is stored with the VoiceXML data processed by the VoiceXML interpreter 1.

The speech recognition processing unit 8 is a so-called speech recognition engine. Generally, the speech recognition processing unit 8 generates character string data on the basis of the voices captured from the microphone 4. The present embodiment, however, aims at the dialog recording process, and hence the speech recognition processing unit 8 executes a function of transferring the voice data captured from the microphone 4 to the dialog recording tag processing unit 2.

The speech synthesis processing unit 9 generates the voice data from the character string data, and controls (the process) so that a voice is uttered from the speaker 6 via the voice output interface 7. In the present embodiment, the speech synthesis processing unit 9, according to an instruction given from the dialog recording tag processing unit 2, utters the synthesized voice data from the speaker 6 and provides the voice data to the dialog recording tag processing unit 2.

The voice record processing unit 10, according to the instruction of the dialog recording tag processing unit 2, stores the voice data based on the synthetic utterance and the voice data based on the user's utterance in the dialog recording file 11, the synthetic utterance recording file 12 and the user's utterance recording file 13.

In this case, the dialog recording file 11 is stored with the voice data in which the synthetic utterance and the user's utterance are combined. At this time, the dialog recording file 11 is stored with a dialog content in a predetermined scope. The predetermined scope connotes a combination (the scope defined by the tags) starting from a synthetic utterance (a query given to the user) prepared beforehand by the VoiceXML in the VoiceXML document storage unit 3 up to a user's answer to this query. Further, the predetermined scope connotes a dialog containing the user's utterances up to predetermined limit time after a termination of the synthetic utterance. Still further, the predetermined scope connotes a dialog content ranging from the start of the user's utterance after the termination of the synthetic utterance up to an occurrence of predetermined non-utterance time (silence status). In this case, the voice data may be stored in a way that combines plural couples of the synthetic utterances and the user's utterances (e.g., a plurality of queries and a plurality of answers to these queries).

On the other hand, the synthetic utterance recording file 12 and the user's utterance recording file 13 are stored with the synthetic utterances and the user's utterances in separation. In the present embodiment, the synthetic utterance recording file 12 is stored with the voice data corresponding to a series of synthetic utterances. The series of synthetic utterances connotes an utterance content up to an interruption (pause) of the synthetic utterance after the start of the synthetic utterance. Further, the user's utterance recording file 13 is stored with the voice data corresponding to a series of user's utterances. The series of user's utterances connotes an utterance content up to an interruption (pause) of the user's utterance after the start of the user's utterance. If over the predetermined limit time, however, the operation may not cause any inconvenience by processing on the assumption that the user's utterance is interrupted.

The dialog recording management file 14 is stored with combined information obtained in such a way that the dialog recording tag processing unit 2 organizes the dialog contents by combining the synthetic utterance recording file 12 with the user's utterance recording file 13. The dialog recording management file 14 itself is described in the VoiceXML format, and hence the VoiceXML interpreter 1 processes the dialog recording management file 14, whereby the dialog is reproduced.

When the VoiceXML data contains tags instructing the execution of recording the dialog (which will hereinafter be referred to as dialog recording tags), the VoiceXML interpreter 1 instructs the dialog recording tag processing unit 2 to record the dialog.

Then, the dialog recording tag processing unit 2 instructs the speech recognition processing unit 8 to notify of the voice data based on the user's utterance captured from the microphone 4. Further, the dialog recording tag processing unit 2 instructs the speech synthesis processing unit 9 to notify of the synthesized voice data. Then, the dialog recording tag processing unit 2 transfers the notified voice data to the voice record processing unit 10 and makes the voice record processing unit 10 to store the voice data in the respective files. Moreover, the dialog recording tag processing unit 2 generates the data of the dialog recording management file 14 for combining the synthetic utterances with the user's utterances.

The VoiceXML interpreter 1, the dialog recording tag processing unit 2, the speech recognition processing unit 8, the speech synthesis processing unit 9 and the voice record processing unit 10 described above are defined as computer programs executed on the CPU. Further, the VoiceXML document storage unit 3, the dialog recording file 11, the synthetic utterance recording file 12, the user's utterance recording file 13 and the dialog recording management file 14 are respectively defined as data files on the hard disk.

### Data Example

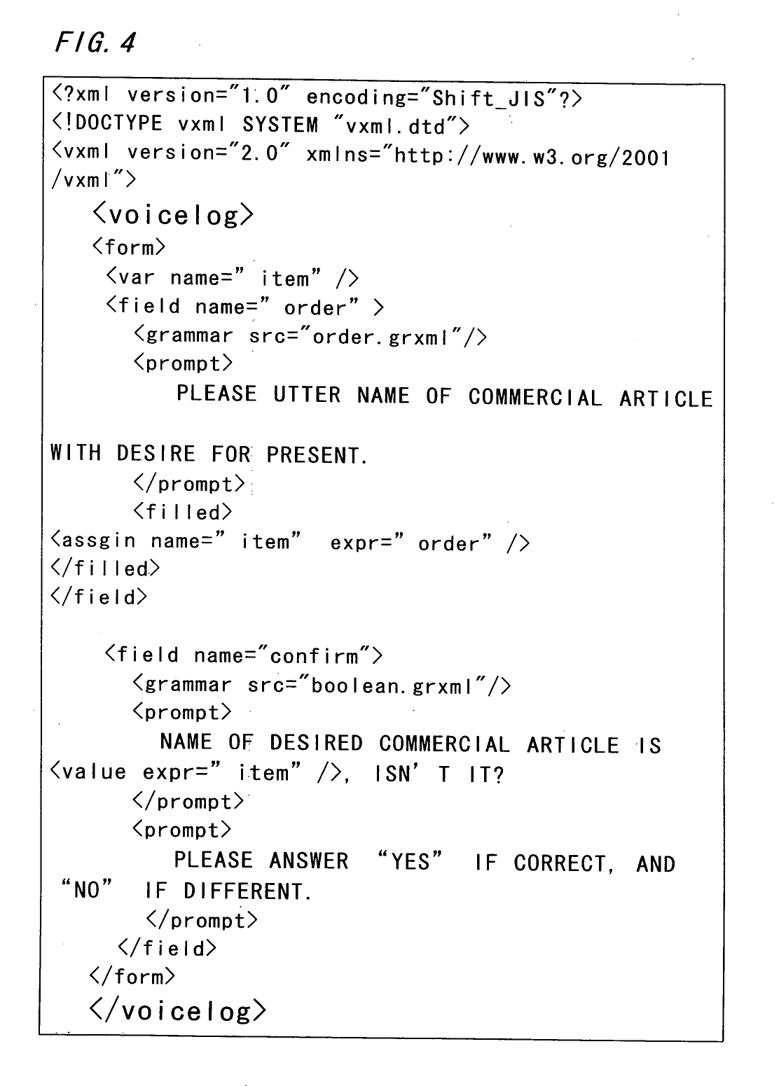

FIG. 4 shows a description example of the VoiceXML data containing the dialog recording tags. A dialog recording tag <voicelog> in the VoiceXML data represents a start of the process (dialog recording process). Moreover, a dialog recording tag </voicelog> represents an end of the process.

The VoiceXML interpreter 1, when detecting the tag <voicelog> in the VoiceXML data, executes the dialog recording tag processing unit 2 (program). When the dialog recording tag processing unit 2 is executed, the VoiceXML interpreter 1 stores the utterance contents in the respective data files by linking up with the speech recognition processing unit 8 and the speech synthesis processing unit 9.

For example, the VoiceXML interpreter 1, when detecting a tag set and a text character string such as “<prompt> Please utter name of commercial article with desire for present. </prompt>”, instructs the speech synthesis processing unit 9 to synthesize a voice corresponding to the character string of “Please utter name of commercial article with desire for present.” and to output the synthesized voice from the speaker 6.

Further, the VoiceXML interpreter 1, after the termination of this synthetic utterance, waits for the user to utter a voice for a predetermined period of time, and makes the speech recognition processing unit 8 to capture the voice data of the user's utterance. The voice data are captured till the user's utterance is interrupted (till silence continues for a predetermined period since an occurrence of silence time) or captured for a predetermined period of time.

At this time, the dialog recording tag processing unit 2 captures and stores the voce data of the synthetic utterance and the voice data of the user's utterance. Then, the VoiceXML interpreter 1, when detecting the tag </voicelog>, instructs the dialog recording tag processing unit 2 to finish recording the dialog. The dialog recording tag processing unit 2, after executing the predetermined process, terminates the program.

Note that FIG. 4 exemplifies the example in which the VoiceXML data contains one tag set such as <voicelog>, </voicelog> and may also contain a plurality of these tag sets.

Furthermore, a tag <form> generally represents a start of the dialog in the VoiceXML. In the example in FIG. 4, a scope from <voicelog> to </voicelog> is defined outside a scope from <form> to </form> where the dialog process is executed. In this case, all of (the contents of) the dialog process becomes a dialog recording object.

In place of this structure, the scope from <voicelog> to </voicelog> my also be contained within the scope of the dialog process ranging from <form> to </form>. In this case, part of the dialog process can be set as the dialog recording content.

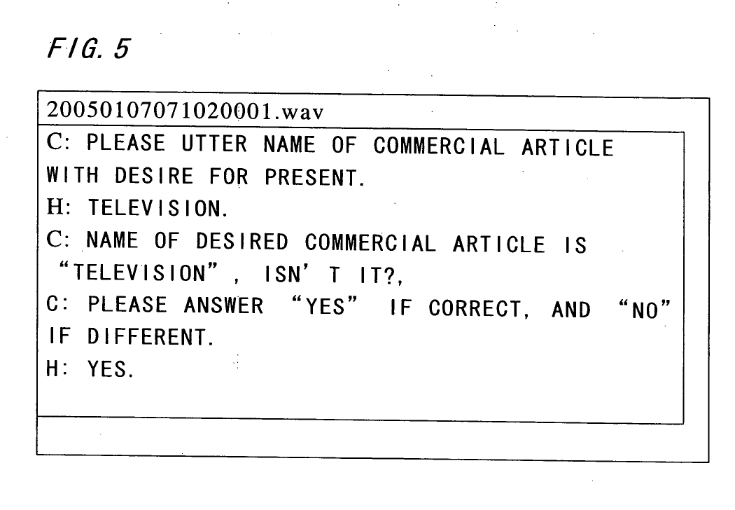

FIG. 5 shows an example of the dialog contents contained in the dialog recording file 11. In this example, a series of dialog (three queries of the synthetic utterances and two answers of the user's utterances) organized by the VoiceXML data shown in FIG. 4 is stored as the voice data. Herein, a symbol “C:” represents that the utterer is the computer, while “H:” represents that the utterer is the person (human).

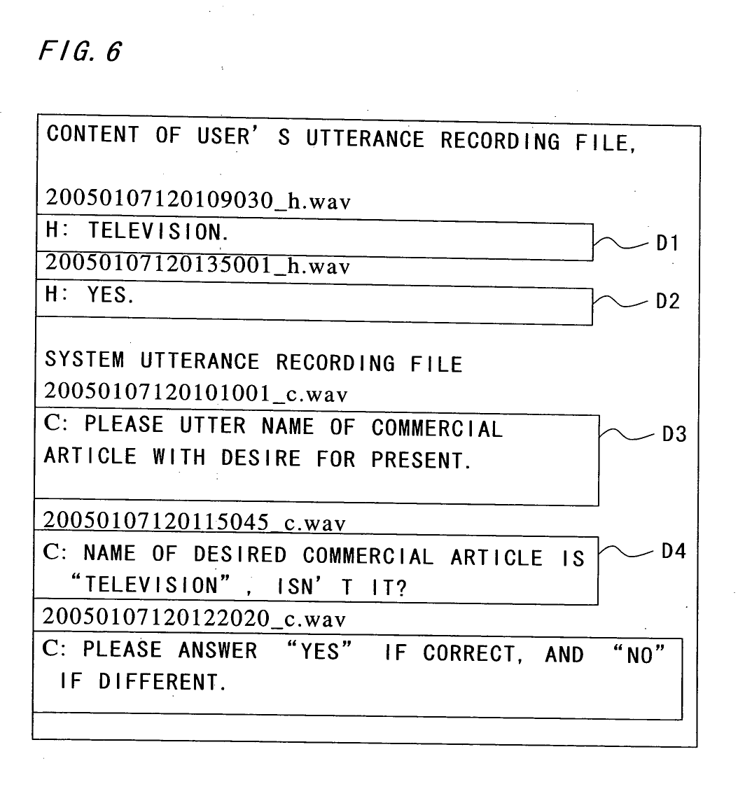

FIG. 6 shows examples of the synthetic utterance recording file 12 and of the user's utterance recording file 13. FIG. 6 shows the examples where the series of synthetic utterances and the series of user's utterances in the same contents of the utterances as in those FIG. 5, are stored respectively in the different files.

For instance, the user's utterance “Television” is stored in a data file D1 (file name: 20050107120109030_h.wav). Further, the user's utterance “Yes” is stored in a data file D2 (file name: 20050107120135001_h.wav).

Moreover, the synthetic utterance “Please utter name of commercial article with desire for present.” is stored in a data file D3 (file name: 20050107120101001_h.wav). Furthermore, the synthetic utterance “Name of desired commercial article is “Television” isn't it?” is stored in a data file D4 (file name: 20050107120115045_h.wav).

Thus, the series of synthetic utterances and the series of user's utterances are stored respectively in the synthetic utterance recording file 12 and in the user's utterance recording file 13 (till the silence status occurs after the start of the utterance).

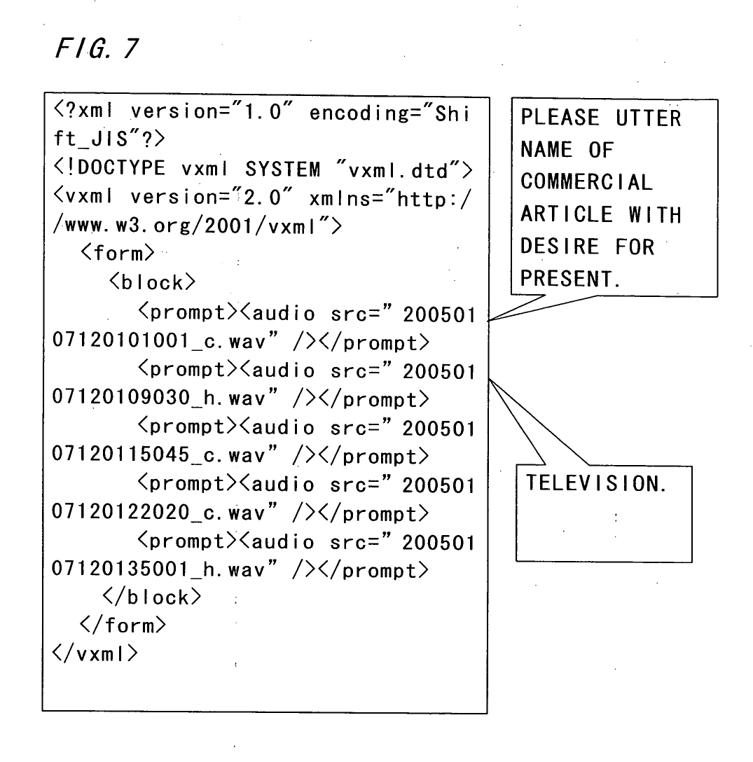

FIG. 7 shows an example of the dialog recording management file 14. The dialog recording management file 14 contains pieces of information for organizing the dialog by connecting the respective contents of the utterances when storing the contents of the utterances shown in FIG. 5 in the synthetic utterance recording files (D3-D5) and in the user's utterance recording files (D1, D2) shown in FIG. 6.

In the present embodiment, the dialog recording management file 14 explicitly shows names of the voice data files corresponding to the contents of the utterances of the dialog.

For example, in FIG. 7, “<prompt><audio src=” 20050107120101001_c.wav”/></pompt>” represents that the voice data is stored in the file named “20050107120101001_c.wav”. The file name of this voice data is described as an src parameter of the tag <prompt>. Therefore, when the VoiceXML interpreter 1 processes the dialog recording management file 14, it follows that the voice data from the tag <prompt> is reproduced. This is the same with other lines, for example, “<prompt><audio src=” 20050107120109030_c.wav”/></pompt>”. Accordingly, the same dialog as in the dialog recording file 11 shown in FIG. 5 is reproduced by combining the dialog recording management file 14, the synthetic utterance recording file 12 and the user's utterance recording file 13.

### Processing Flow

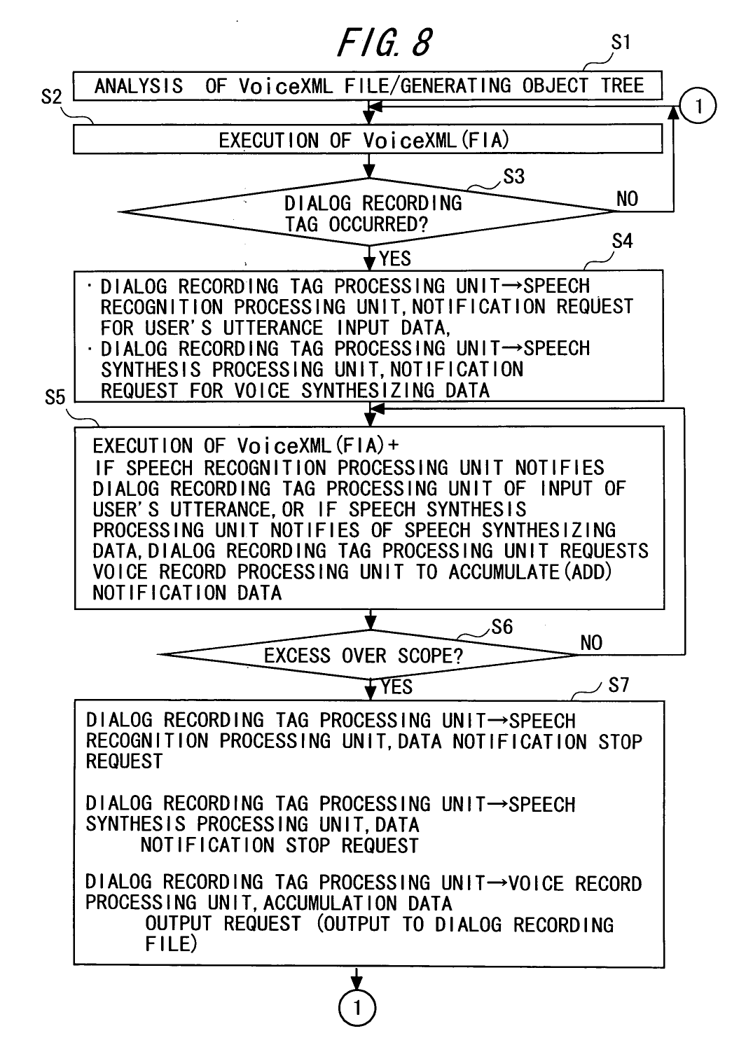

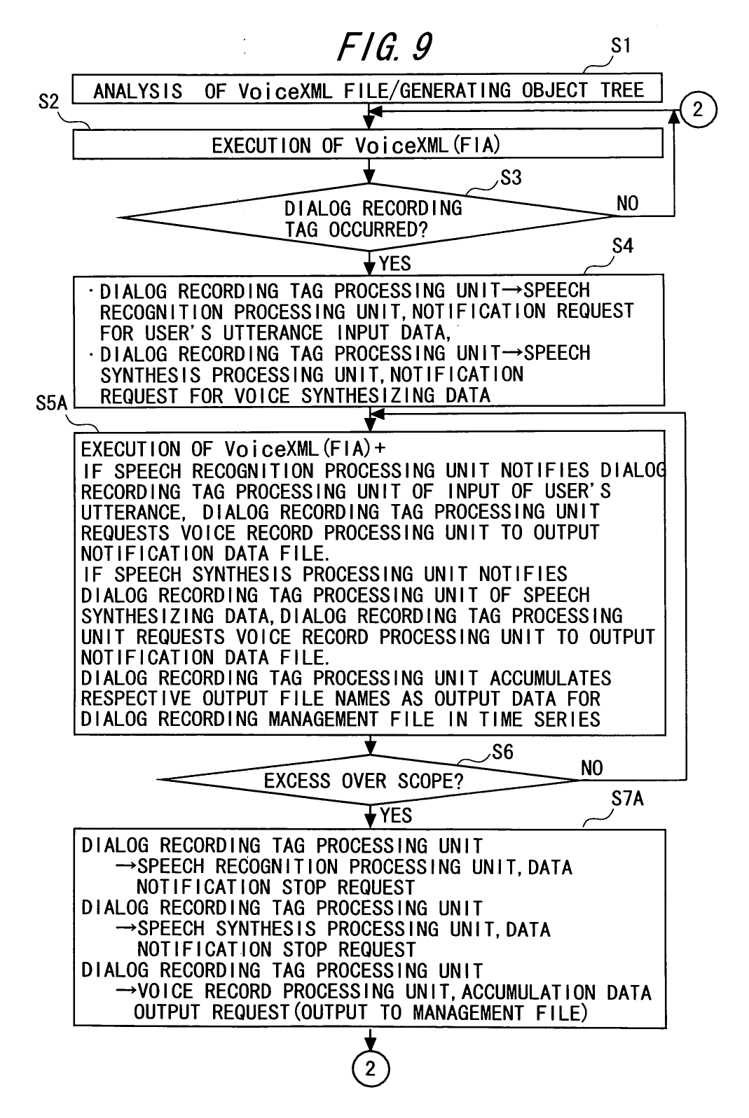

FIGS. 8 and 9 show the processes of the information processing apparatus (the VoiceXML interpreter 1). FIG. 8 shows an example of the process of recording the dialog in a format where the synthetic utterances and the user's utterances are connected in the same voice data file as shown in FIG. 5.

In this process, at first, the VoiceXML interpreter 1 serving as the information processing apparatus analyzes the VoiceXML file and generates an execution object tree (S1). The execution object tree is such data that a tag hierarchical structure in the VoiceXML file is defined by a three structure. The VoiceXML interpreter 1 executes the process according to the execution object tree (S2). This process is called FIA (Form Interpretation Algorithm). In this process, the VoiceXML interpreter 1 judges whether the dialog recording tag “<voicelog>” occurs or not (S3). Till the dialog recording tag “<voicelog>” occurs, the VoiceXML interpreter 1 repeats the normal FIA process (S2).

On the other hand, when the dialog recording tag “<voicelog>” occurs, the VoiceXML interpreter 1 prompts the dialog recording tag processing unit 2 to start the process. At this time, the dialog recording tag processing unit 2 requests the speech recognition processing unit 8 to notify of the inputted voice data when detecting the user's utterance. Further, the dialog recording tag processing unit 2 requests the speech synthesis processing unit 9 to notify of the synthesized voce data when synthesizing the synthetic utterance (S4).

Then, the VoiceXML interpreter 1 continues the execution of the VoiceXML file (S5). In this process, when the speech recognition processing unit 8 notifies the dialog recording tag processing unit 2 of the voice data uttered by the user, or when the speech synthesis processing unit 9 notifies of the speech synthetic data, the dialog recording tag processing unit 2 requests the voice record processing unit 10 to accumulate (add) the notified data (S5).

Then, the VoiceXML interpreter 1 judges whether an excess over the scope of the dialog recording tag occurs or not (S6). This judgment is judgment as to whether “</voicelog>” representing the end of the dialog recording process is detected or not. Thus, the information processing apparatus repeats the process in S5 till exiting the scope.

Then, in the case of exiting the scope defined by the dialog recording tags (tag set), the VoiceXML interpreter 1 makes the dialog recording tag processing unit 2 stop the process. At this time, the dialog recording tag processing unit 2 requests the speech recognition processing unit 8 to stop notifying of the voice data. Further, the dialog recording tag processing unit 2 requests the speech synthesis processing unit 9 to stop notifying of the voice data. Then, the dialog recording tag processing unit 2 requests the dialog record processing unit 10 to output the accumulated voice data to the dialog recording file 11 (S7). Thereafter, the VoiceXML interpreter 1 returns the control to S2, and executes the process for the next tag.

FIG. 9 shows an example of the processes of storing, as shown in FIGS. 6 and 7, the series of synthetic utterances and the series of user's utterances in the voice data files different from each other and connecting these utterances in the dialog recording management file 14. Except the point described above, the processes in FIG. 9 are the same as the processes in FIG. 8. Such being the case, the same processes are marked with the same symbols as those in FIG. 8, and their explanations are omitted. It is to be noted that the processes in FIG. 8 and the processes in FIG. 9 may be executed by the information processing apparatus exchangeably according to, e.g., the user's setting.

As shown in FIG. 9, the dialog recording tag “<voicelog>” occurs, and, after the dialog recording tag processing unit 2 has started processing (after S4), the speech recognition processing unit 8 notifies the dialog recording tag processing unit 2 of the voice data uttered by the user, in which case the dialog recording tag processing unit 2 requests the voice record processing unit 10 to output the file of the notified data. Further, when the speech synthesis processing unit 9 notifies the dialog recording tag processing unit 2 of the speech synthetic data, the dialog recording tag processing unit 2 requests the voice record processing unit 10 to output the file of the notified data. The dialog recording tag processing unit 2 accumulates in time series the respective output file names as the output data in the dialog recording management file 14 (S5A).

Then, in the case of exiting the scope of the dialog recording tags, the VoiceXML interpreter 1 makes the dialog recording tag processing unit 2 stop the process. At this time, the dialog recording tag processing unit 2 requests the speech recognition processing unit 8 to stop notifying of the voice data. Further, the dialog recording tag processing unit 2 requests the speech synthesis processing unit 9 to stop notifying of the voice data. Then, the dialog recording tag processing unit 2 outputs, based on the output file names accumulated in time series, the VoiceXML data (see FIG. 7) to the dialog recording management file 14.

As discussed above, according to the information processing apparatus in the present embodiment, on the basis of the dialog recording tags, it is possible to record the dialog contents that are the combination of the content of the synthetic utterances uttered by the information processing apparatus and the content of the user's utterance as the user's answer to the synthetic utterance. In this case, the user may simply answer to the synthetic utterance, and hence, without being aware of being recorded and paying attention to the points of time when starting the utterance and when terminating the utterance, the dialog contents can be conveyed to the system by naturally answering to the utterance of the information processing apparatus.

Further, according to the information processing apparatus, the dialog contents may be stored in one dialog recording file 11 and may also be managed in the dialog recording management file 14 in a way that delimits the synthetic utterance and the user's utterance for every series of utterances and stores these utterances differently in the synthetic utterance recording file 12 and in the user's utterance recording file 13.

Moreover, according to the information processing apparatus, a plurality of user's utterance contents can be recorded by setting one dialog recording tag set in a way that inserts the dialog portion (which is the scope from <form> to </form>) of the synthetic utterances and the user's utterances of a plurality of users into the scope defined by the dialog recording tag set.

### Modified Example

In the first embodiment discussed above, the synthetic utterances and the user's utterances are combined and thus stored in the dialog recording file 11 or managed in the dialog recording management file 14. In this case, any one of the synthetic utterances and the user's utterances may be recorded according to a parameter (an attribute of the process) attached to the dialog recording tag. Further, the recording of both or any one of the synthetic utterances and the user's utterances may be changed over according to the attribute.

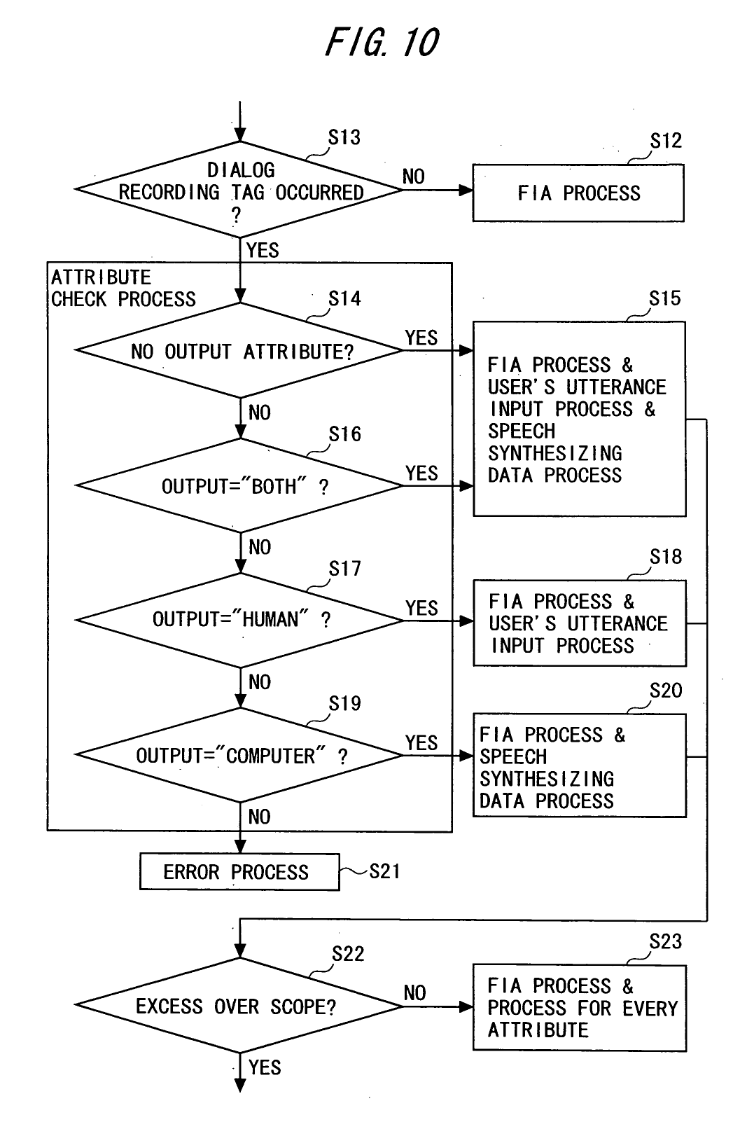

FIG. 10 shows an example of the process of the attribute attached to the dialog recording tag. Omitted in this process are the process of analyzing the VoiceXML file and the process of generating the execution object tree shown in FIGS. 8 and 9. The process after executing the process (S2 in FIGS. 8 and 9) based on the first FIA will hereinafter be explained.

The VoiceXML interpreter 1 judges whether or not the dialog recording tag occurs (S13). Till the occurrence of the dialog recording tag, the VoiceXML interpreter 1 repeats the normal FIA process (S12).

On the other hand, when the dialog recording tag occurs, the VoiceXML interpreter 1 checks the attribute attached to the tag. To begin with, if no designation of the attribute is given (a case of YES in S14), the VoiceXML interpreter 1, as in the case of FIGS. 8 and 9, processes both of the user's utterance and the synthetic utterance along with the FIA process (S15).

Further, if the designation of the attribute is “both” (a case of YES in S16), the VoiceXML interpreter 1 processes both of the user's utterance and the synthetic utterance along with the FIA process (S15).

Still further, if the designation of the attribute is “human” (a case of YES in S17), the VoiceXML interpreter 1 processes only the user's utterance along with the FIA process (S18). In this case, it follows that the synthetic utterance is not recorded.

Yet further, if the designation of the attribute is “computer” (a case of YES in S19), the VoiceXML interpreter 1 processes only the synthetic utterance along with the FIA process (S20). In this case, it follows that the user's utterance is not recorded.

Moreover, if the designation of an attribute other than the attribute described above is given, the VoiceXML interpreter 1 executes an error process (S21).

The VoiceXML interpreter 1 judges by repeating these processes whether the operation exits the scope or not (S22). In the case of not exiting the scope, the processes based on the FIA and the attribute are repeated (S23). While on the other hand, in the case of exiting the scope, the dialog recording process is terminated.

As described above, according to the processes in FIG. 10, the process of recording any one or both of the synthetic utterance and the user's utterance can be changed over based on the tag attribute.

### Recording Medium Readable by Computer

A program for making a computer, other machines, devices (which will hereinafter be referred to as the computer etc) actualize any one of the functions given above can be recorded on a recording medium readable by the computer etc. Then, the computer etc is made to read and execute the program on this recording medium, whereby the function thereof can be provided.

Herein, the recording medium readable by the computer etc connotes a recording medium capable of storing information such as data and programs electrically, magnetically, optically, mechanically or by chemical action, which can be read from the computer etc. Among these recording mediums, for example, a flexible disk, a magneto-optic disk, a CD-ROM, a CD-R/W, a DVD, a DAT, an 8 mm tape, a memory card, etc are given as those demountable from the computer etc.

Further, a hard disk, a ROM (Read-Only Memory), etc are given as the recording mediums fixed within the computer etc.

### Others

The disclosures of Japanese patent application No. JP2006-072864 filed on Mar. 16, 2006 including the specification, drawings and abstract are incorporated herein by reference.

What is claimed is:

1. A processing apparatus of Markup Language information containing tag information for instructing execution of a predetermined function, comprising:
an interface making connectable a voice acquisition unit;
an interface making connectable a voice output unit;
a voice acquisition control unit acquiring a voice as voice data via the voice acquisition unit;
a voice output control unit outputting the voice via the voice output unit;
a voice data storage unit stored with the voice data;
a recording tag recognition unit recognizing a recording tag representing a start of recording;
a recording termination tag recognition unit recognizing a recording termination tag representing termination of recording; and
a voice data storage control unit having the voice data storage unit stored with the voice data acquired by the voice acquisition control unit during a period and having the voice data storage unit stored with a voice as voice data outputted by the voice output control unit, till the recording termination tag is recognized after the recording tag has been recognized.

2. The processing apparatus of Markup Language information according to claim 1, wherein the voice data storage control unit connects the acquired voice data with the voice data of the outputted voice in a timer-series order at a point of time when being acquired and at a point of time when being outputted, and stores these pieces of voice data as one set of voice data.

3. The processing apparatus of Markup Language information according to claim 1, wherein the voice data storage control unit includes:
a data file storing unit storing the acquired voice data and the voice data of the outputted voice in a data file corresponding to the point of time when being acquired and in a data file corresponding to the point of time when being outputted; and
an order recording unit recording, in an order storage file, a relationship of the time-series order with respect to the data file corresponding to the point of time when being acquired and the data file corresponding to the point of time when being outputted.

4. The processing apparatus of Markup Language information according to claim 1, further comprising an attribute recognition unit recognizing attribute information when storing the voice data,
wherein the voice data storage control unit has any one or both of the acquired voice data and the voice data of the outputted voice stored according to the attribute information.

5. An information processing method by which a computer including a voice acquisition control unit acquiring a voice as voice data via the voice acquisition unit, a voice output control unit outputting the voice via a voice output unit and a voice data storage unit stored with the voice data, processes Markup Language information containing tag information for instructing execution of a predetermined function, the method comprising:
a recording tag recognition step of recognizing a recording tag representing a start of recording;
a recording termination tag recognition step of recognizing a recording termination tag representing termination of recording; and
a voice data storage control step of having the voice data storage unit stored with the voice data acquired by the voice acquisition control unit during a period and having the voice data storage unit stored with a voice as voice data outputted by the voice output control unit, till the recording termination tag is recognized after the recording tag has been recognized.

6. The information processing method according to claim 5, wherein the voice data storage control step includes connecting the acquired voice data with the voice data of the outputted voice in a timer-series order at a point of time when being acquired and at a point of time when being outputted, and storing these pieces of voice data as one set of voice data.

7. The information processing method according to claim 5, wherein the voice data storage control step includes:
a data file storing step of storing the acquired voice data and the voice data of the outputted voice in a data file corresponding to the point of time when being acquired and in a data file corresponding to the point of time when being outputted; and
an order recording step of recording, in an order storage file, a relationship of the time-series order with respect to the data file corresponding to the point of time when being acquired and the data file corresponding to the point of time when being outputted.

8. The information processing method according to claim 5, further comprising an attribute recognition step of recognizing attribute information when storing the voice data,
wherein the voice data storage control step includes having any one or both of the acquired voice data and the voice data of the outputted voice stored according to the attribute information.

9. A recording medium recorded with a program executable by a computer, for making a computer including a voice acquisition control unit acquiring a voice as voice data via the voice acquisition unit, a voice output control unit outputting the voice via a voice output unit and a voice data storage unit stored with the voice data, process Markup Language information containing tag information for instructing execution of a predetermined function, the program comprising:
a recording tag recognition step of recognizing a recording tag representing a start of recording;
a recording termination tag recognition step of recognizing a recording termination tag representing termination of recording; and
a voice data storage control step of having the voice data storage unit stored with the voice data acquired by the voice acquisition control unit during a period and having the voice data storage unit stored with a voice as voice data outputted by the voice output control unit, till the recording termination tag is recognized after the recording tag has been recognized.

10. The recording medium recorded with the program executable by a computer according to claim 9, wherein the voice data storage control step includes connecting the acquired voice data with the voice data of the outputted voice in a timer-series order at a point of time when being acquired and at a point of time when being outputted, and storing these pieces of voice data as one set of voice data.

11. The recording medium recorded with the program executable by a computer according to claim 9, wherein the voice data storage control step includes:
a data file storing step of storing the acquired voice data and the voice data of the outputted voice in a data file corresponding to the point of time when being acquired and in a data file corresponding to the point of time when being outputted; and
an order recording step of recording, in an order storage file, a relationship of the time-series order with respect to the data file corresponding to the point of time when being acquired and the data file corresponding to the point of time when being outputted.

12. The recording medium recorded with the program executable by a computer according to claim 9, further comprising an attribute recognition step oft recognizing attribute information when storing the voice data,
wherein the voice data storage control step includes having any one or both of the acquired voice data and the voice data of the outputted voice stored according to the attribute information.
